(19) United States
(12) Patent Application Publication
(10) Pub. No.: US 2007/0262585 A1
(43) Pub. Date: Nov. 15, 2007

(54) Auto wind TEC fan

(76) Inventor: Keith Rendell, Yeovil (GB)

Correspondence Address: Galasso & Associates, LP, P.O. Box 26503, Austin, TX, 78755-0503, US

(21) Appl. No.: 11/432,703

(22) Filed: May 10, 2006

(51) Int. Cl. F03D 9/00

(52) U.S. Cl. 290/55

(57) ABSTRACT

Auto Wind TEC Fan consists of a housing with an air-intake opening. Within the housing, a turbine and a generator are located. Lead lines connect to the generator to permit the electrical power generated to be utilized. In addition, a duct connects on one end to the housing and on the other end to a conduit having air nozzles. To use Auto Wind TEC Fan, a car operator would start the engine and drive the vehicle in an ordinary manner. Wind passing into the air-intake opening will be directed into the housing. The wind will rotate the turbine within the housing. The turbine will operate the generator to produce electricity that can be harnessed for use with the electrical components of the vehicle or to power the vehicle. The wind will also pass through the duct and into the conduit and the air nozzles to allow the wind to operate as windshield wipers when the car is moving.

### CROSS REFERENCE TO RELATED APPLICATIONS

This Non-Provisional patent application does not claim priority to any United States provisional application or foreign application.

### FIELD OF THE DISCLOSURE

The disclosures made herein relate generally to a wind-powered generator for an automobile. The invention discussed herein is in the general classification of automotive devices.

### BACKGROUND

Millions of people drive automobiles everyday. Unfortunately, the exhaust from gasoline-powered automobiles contributes to global pollution. Vehicle emissions cause a variety of environmental problems, creating a need for alternatively powered vehicles. The dwindling supply of fossil fuels along with the high costs associated with such fuels also have created a need for alternative power sources for cars and the like. Electric-powered cars and trucks are some of the most promising alternatives to traditional gasoline-powered vehicles.

Many vehicles, whether gasoline-powered or electric-powered, are also equipped with a wide variety of electric-powered features for the comfort and entertainment of passengers. Vehicles usually have an air conditioning system, a heating system, a dashboard-mounted clock, an interior light, an AM/FM radio, automatic seat belts, a CD player, an audio tape player, a video cassette player, front headlights and rear taillights. Vehicles also have windshield wipers that utilize electrical power.

Traditional electric windshield wipers have been used for over a century in the United States. These wipers consist of a pair of plastic arms operated electronically that attach to rubber wiper blades. The plastic arms are attached beneath the windshield at two pivot points. The arms can operate at various speeds and create an arc pattern as they move back and forth across a windshield. When the wiper blades are new, the rubber is clean and has no nicks or cracks. The blades wipe rainwater or other debris away without leaving streaks on the windshield. When wiper blades age, nicks or cracks form and road grime builds up on the edges. As a result, the wiper blades do not make as tight a seal against the windshield. Wiper blades are designed to attach in a single point in the middle of the plastic arms, but a series of other arms branch out from the middle like a tree, so the blade is actually connected in six to eight places. If ice or snow forms on these arms, it can make the distribution of pressure uneven, causing streaks under part of the blade.

The use of various electrical products inside a vehicle and to power the vehicle itself puts a considerable strain on a car's battery. This can drain a battery's power and cause the battery to wear out quickly. To date, no adequate product exists to assist the car's battery in powering the various electrical devices used in a vehicle or in running the vehicle itself.

Hence, there is a need in the art for an alternative source of power that allows a vehicle owner to operate various electrical devices without utilizing the car's battery. There is also a need in the art for an alternative source for powering an electric vehicle. There is further a need in the art for an alternative type of windshield wiper that will not wear out or need to be replaced.

### SUMMARY OF THE DISCLOSURE

Auto Wind TEC Fan consists of a housing with an air-intake opening. Within the housing, a turbine and a generator are located. Lead lines connect to the generator to permit the electrical power to be utilized. In addition, a duct connects on one end to the housing and on the other end to a conduit, having air nozzles. To use Auto Wind TEC Fan, a car operator would start the engine and drive the vehicle in an ordinary manner. Wind passing over and into the vehicle will be directed into the housing through the air-intake opening. The wind will rotate the turbine within the housing. The turbine will operate the generator to produce electricity that can be harnessed for use with the electrical components of the vehicle or to simply charge the vehicle's battery. The wind would also pass through the duct and into the air nozzles to allow the wind to operate as an alternative to windshield wipers when the car is moving.

The principal object of this invention is to provide an alternative power source to a vehicle's battery for operating the various electrical components of a vehicle.

Another object of this invention is to provide an alternative power source that can be used to power electric vehicles.

Another object of this invention is to provide an affordable and environmentally friendly alternative power source for a vehicle.

Yet another object of this invention is to provide an alternative type of windshield wiper that operates on air power and does not need to be changed or replaced.

### BRIEF DESCRIPTION OF THE DRAWINGS

FIG. 1 depicts a perspective view of the preferred embodiment of the invention.

FIG. 2 depicts a perspective view of the turbine and generator located within the housing of the preferred embodiment of the invention.

### DETAILED DESCRIPTION OF THE DRAWINGS

The preferred embodiment of Auto Wind TEC Fan is comprised of at least some of the following: a housing with an air-intake cone, a turbine, a generator attached to lead lines, a duct, a U-shaped conduit and air nozzles.

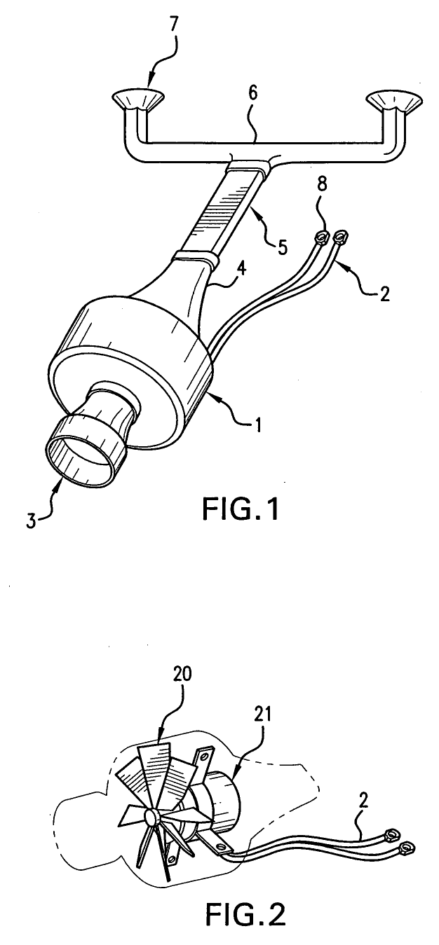

In the preferred embodiment of the invention, shown in FIG. 1, a roughly cylindrical housing 1 contains a plastic turbine (not pictured) and a generator (not pictured). The housing 1 is made of high-quality, corrosion-resistant metal and is approximately twelve inches in diameter. The generator connects to wiring (lead lines) 2 emerging from an opening in the housing 1. The lead lines 2 are insulated for safety and have metal contact points 8 at their ends for ease of use.

The front of the housing 1 has a metal air-intake cone 3 that is approximately eight inches in diameter at the top of the cone and six inches in diameter at the bottom of the cone. The rear of the housing 1 has a tapered conduit 4 leading to a duct 5. The duct 5 is approximately rectangular in shape and made of metal. The rear of the duct 5, opposite the side connected to the tapered conduit 4, attaches to a U-shaped conduit 6 with air nozzles 7 on each of the tips of the U-shaped conduit 6. The U-shaped conduit 6 is also made of metal. The air nozzles 7 are operatively connected to the battery of the vehicle and capable of pivoting. The air nozzles 7 are positioned directly beneath the windshield of a vehicle to allow the air exiting them to stream across the windshield.

FIG. 2 shows a perspective view of the turbine 20 and generator 21 located under the housing of the preferred embodiment of the invention. The turbine 20 spins when its plastic blades are contacted by the wind entering the housing. The turbine has a shaft (not pictured) that rotates with the blades. The shaft is connected to the generator 21 that contains magnets (not pictured) and wires (not pictured). As the magnet inside the generator turns, an electric current is produced in the wires, converting mechanical moving energy into electrical energy. The generator connects to the lead lines 2 protruding from the housing that can then interact with the battery to power various electrical devices in the car or the car itself.

The unit ideally would be positioned in the front of the vehicle to capture wind, preferably in the grill area. A car operator would simply start the engine of the vehicle and begin driving the vehicle in an ordinary manner. Wind passing over and into the vehicle's grill will be directed into the housing through the air-intake cone. The wind will rotate the turbine within the housing that will in turn operate the generator to produce electricity that can be harnessed for use with the electrical components of the vehicle or to charge the battery of the vehicle. The wind would also pass through the tapered conduit into the duct and then into the U-shaped conduit and finally through the air nozzles. The air emitted from the air nozzles would clear the windshield of the moving vehicle. The air nozzles will be connected to a switch the vehicle operator can trigger. When the switch is powered on, the air nozzles will continually pivot to provide coverage of a large portion of the windshield and will operate as an alternative to traditional windshield wipers.

The components of Auto Wind TEC Fan may vary widely but will likely use metal, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Auto Wind TEC Fan can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the housing of the present invention can be of various shapes and sizes. It should also be obvious that the housing and other components of the invention can be made of different types of metals, plastics or other suitable materials and can be of any color. It should further be obvious that although the present invention is ordinarily used within cars and trucks, it could be used with a large number of motorized vehicles or devices. Such vehicles or devices include ships, trains, farm equipment, construction equipment and hybrid vehicles. While the present invention is ideally situated in the forward grill area of a vehicle, it could be located in any suitable location for capturing wind as the vehicle is in motion. In addition, while the preferred embodiment of the invention has two air nozzles, any number could be utilized and remain within the spirit of the invention.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A power harnessing device comprising:
(a) a housing with an intake opening attached to a vehicle; and
(b) a turbine connected to a generator within the housing.

2. The power harnessing device of claim 1 wherein the housing is metal.

3. The power harnessing device of claim 2 wherein the housing is corrosion-resistant.

4. The power harnessing device of claim 1 wherein the housing is approximately cylindrical.

5. The power harnessing device of claim 1 wherein the generator is attached to a wire.

6. The power harnessing device of claim 5 wherein the wire is insulated.

7. The power harnessing device of claim 6 wherein the wire has a metal contact point on one end.

8. The power harnessing device of claim 1 wherein the turbine is plastic.

9. The power harnessing device of claim 1 further comprising
an air-intake cone attached to the intake opening.

10. The power harnessing device of claim 9 wherein the air-intake cone is made of metal.

11. The power harnessing device of claim 1 wherein the housing has a tapered conduit leading to a duct.

12. The power harnessing device of claim 11 wherein the duct is approximately rectangular and made of metal.

13. The power harnessing device of claim 11 wherein the duct connects to a conduit with an air nozzle.

14. The power harnessing device of claim 13 wherein the conduit is U-shaped.

15. The power harnessing device of claim 13 wherein the air nozzle is operatively connected to a battery of the vehicle and capable of pivoting.

16. A power harnessing device comprising:
(a) a housing attached to a vehicle with said housing made of corrosion-resistant metal and approximately cylindrical in shape and further having a metal air-intake cone on the front of the housing and a tapered conduit on the rear of the housing;
(b) a turbine made of plastic connected to a generator within the housing;
(c) a plurality of insulated wires with metal contact points connected to the generator;
(d) a duct that is approximately rectangular and made of metal connected to the tapered conduit;
(e) a U-shaped conduit connected to the duct and having a first air nozzle and a second air nozzle that are operatively connected to a battery of the vehicle and capable of pivoting.
